(19) United States
(12) Patent Application Publication
(10) Pub. No.: US 2011/0232151 A1
(43) Pub. Date: Sep. 29, 2011

(54) INTEGRAL, FRAME-MOUNTED LASER AIMING DEVICE

(75) Inventor: GARY ZUKOWSKI, Ludlow, MA (US)

(73) Assignee: SMITH & WESSON CORP., Springfield, MA (US)

(21) Appl. No.: 13/074,734

(22) Filed: Mar. 29, 2011

Related U.S. Application Data
(60) Provisional application No. 61/318,557, filed on Mar. 29, 2010.

(51) Int. Cl. F41G 1/35; B23P 19/00

(52) U.S. Cl. 42/114; 42/146; 29/426.1

(57) ABSTRACT

A light emitting apparatus that is installed in an inner recess defined by a lower muzzle portion of a frame of a firearm. The light emitting apparatus is accessible through pass-through holes or openings formed in the lower muzzle portion of the frame. For instance, the light emitting apparatus includes a laser aiming device that emits light through a first opening defined below a barrel of the firearm; activation switches accessible through second openings defined in each side of the frame. The laser aiming device is retained in the inner recess by a hold down screw inserted through a bore therein and into a threaded insert disposed in the bottom surface of the inner recess.

### CROSS REFERENCE TO RELATED APPLICATION

This application claims the benefit of U.S. Provisional Application No. 61/318,557, filed Mar. 29, 2010, entitled “INTEGRAL, FRAME-MOUNTED LASER AIMING DEVICE”, the aforementioned application being hereby incorporated by reference in its entirety.

### FIELD OF THE INVENTION

The invention relates to a light emitting apparatus for a firearm and, more specifically, to an integral, frame-mounted laser aiming device for a pistol.

### BACKGROUND OF THE INVENTION

Laser aiming devices are affixed to firearms to improve the accuracy and precision of the user. In particular, a light emitted from the laser aiming device, such as a laser beam, is aligned with a firing axis of the firearm and disposed as close to the firing axis as possible to reduce the divergence of the laser and the firing axis. However, since the laser beam cannot readily be disposed in the firing axis, some divergence is inevitable.

Therefore, if the distance to the target is known (e.g., 20 meters), the laser aiming device can be adjusted to converge with the firing axis at that distance for improved results. This convergence point is referred to as the point of aim. However, if the distance to the target is not known or is variable, then the laser aiming device can be adjusted to run substantially parallel to the firing axis with a constant distance of deviation (e.g., 3 cm). Since the laser aiming devices are generally affixed outside the frame of the firearm, reducing this constant distance of deviation is difficult in known laser aiming devices.

There is a need for a laser aiming device that reduces this constant distance between the laser of the laser aiming device and the firing axis of the firearm, which run substantially parallel to one another.

Some known laser aiming devices do not even emit a visible laser. For instance, for far field aiming, known laser aiming devices often project a red dot into the sight to indicate where the laser would be without actually transmitting a visible dot. For short field aiming, known laser aiming devices may use other means, such as a laser emitter.

Laser aiming devices are traditionally attached to the firearm in two ways. First, the laser aiming devices can be attached, or otherwise mounted, to the firearm using a clamp. For instance, a laser aiming device can be mounted to a frame of the firearm along one side thereof (hereinafter referred to as a “mounted laser aiming device”). In this case, the laser can be disposed alongside the firearm and displaced outwardly therefrom.

Second, the laser aiming devices can be integrally formed in an after-market grip of the firearm. For instance, a laser aiming device can be integrally formed along one side of the grip, proximate the trigger and generally underlying the barrel (hereinafter referred to as a “grip-integrated laser aiming device”).

Each of these styles of laser aiming devices have certain advantages and disadvantages that must be weighed when deciding which style to use. First, in the mounted laser aiming device, the laser aiming device is highly adjustable and can be easily repositioned to align the laser with the firing axis of the barrel for a given distance to the target. The mounted laser aiming device is also, in general, readily removable or interchangeable for another device, such as another laser aiming device or a scope, if there is a need for repair or a change of configuration. However, interchanging the laser aiming device can require laser-sight collimation when re-attached. In contrast, in the grip-integrated laser aiming device, the laser aiming device is not readily interchangeable.

There is a need for a laser aiming device that is highly adjustable, that is readily installable, repairable and/or interchangeable, that maintains its current positioning unless and until the user intentionally makes an adjustment, and that reduces the need for laser-sight collimation if removed from the firearm.

Second, the mounted laser aiming device is prone to tampering or unintentional adjustment, for instance, if the laser aiming device is bumped, impacted, abraded, or otherwise contacted. Beyond misaligning the mounted laser aiming device, this contact can damage the laser and the mounting means. In contrast, the grip-integrated laser aiming device is generally lower in profile than the mounted laser aiming devices and are semi-protected by the outer surface of the grip of the firearm and is less susceptible to harm or tampering.

There is a need for a laser aiming device that is robust and protected from harmful contact and, therefore, reduces the need for laser-sight collimation.

There is a need for a laser aiming device that is ambidextrous in nature and can be actuated with equal ease whether the firearm is held in the left or right hand of the user.

Fourth, the mounted laser aiming device can significantly increase the overall bulk and balance of the firearm. For instance, the mounted laser aiming device is attached to the exterior surface of the firearm, thereby increasing the overall size of the firearm. Further, the mounted laser aiming device requires mounting means to connect the laser aiming device and the firearm and must be encased within a housing to protect the laser aiming device from potentially harmful contact. Each of these additional components—the mounting means and the housing—increases the overall weight and impacts the balance of the firearm. In comparison, the grip-integrated laser aiming device protrudes from a side of the grip of the firearm, which also increases the overall bulk of the firearm. Further, although a grip-integrated laser aiming device is not as heavy as a mounted laser aiming device, in general, the grip-integrated laser aiming device impacts the lateral balance of the firearm.

There is a need for a laser aiming device that minimizes any impact on the overall bulk and balance of the firearm having the laser aiming device.

The object of the present invention is, therefore, to provide an improved laser aiming device, which, among other desirable attributes, significantly reduces or overcomes the above-mentioned deficiencies of prior mounted or integral-grip laser aiming devices for a firearm.

### SUMMARY OF THE INVENTION

Accordingly, the present invention provides a light emitting apparatus, such as a laser aiming device, that is integral with a frame of a firearm and disposed in a portion of the frame that underlies a barrel of the firearm.

It is an object of the present invention to provide a light emitting apparatus that is integrally formed with the frame of the firearm.

It is an object of the present invention to provide a laser aiming device that is robust and can withstand impacts without the need for laser-sight collimation.

It is an object of the present invention to provide a laser aiming device that is readily adjustable to direct the path of the laser along the firing path of the firearm.

It is an object of the present invention to provide a light emitting apparatus that is readily installed and/or interchangeable with other light emitting apparatus.

It is an object of the present invention to provide a laser aiming device that maintains its current positioning unless and until the user intentionally makes an adjustment.

It is an object of the present invention to provide a light emitting apparatus that is ambidextrous in nature and, thus, is equally accessible from both sides of the firearm.

It is an object of the present invention to provide a laser aiming device that does not significantly impact the bulk or balance of the firearm.

These and other features of the present invention are described with reference to the drawings of preferred embodiments of an integrated, frame-mounted light emitting apparatus for a firearm. The illustrated embodiments of the device of the present invention are intended to illustrate, but not limit, the invention.

### BRIEF DESCRIPTION OF THE DRAWINGS

FIGS. 1-2 illustrate a firearm according to the prior art.

FIG. 3 illustrates a perspective view of the front end of a firearm with an integrated, frame-mounted laser aiming device according to one embodiment of the present invention.

FIG. 4 illustrates another perspective view of the firearm according to the embodiment of FIG. 3.

FIG. 5 illustrates a perspective view of a firearm having an integrated, frame-mounted laser aiming device installed therein, with a slide removed, according to the embodiment of FIG. 3.

FIG. 6 illustrates a perspective view of a firearm having an integrated, frame-mounted laser aiming device that is tilted forward to reveal a thread insert in the frame, with a slide removed and a translucent frame, according to the embodiment of FIG. 3.

### DETAILED DESCRIPTION OF THE PREFERRED EMBODIMENTS

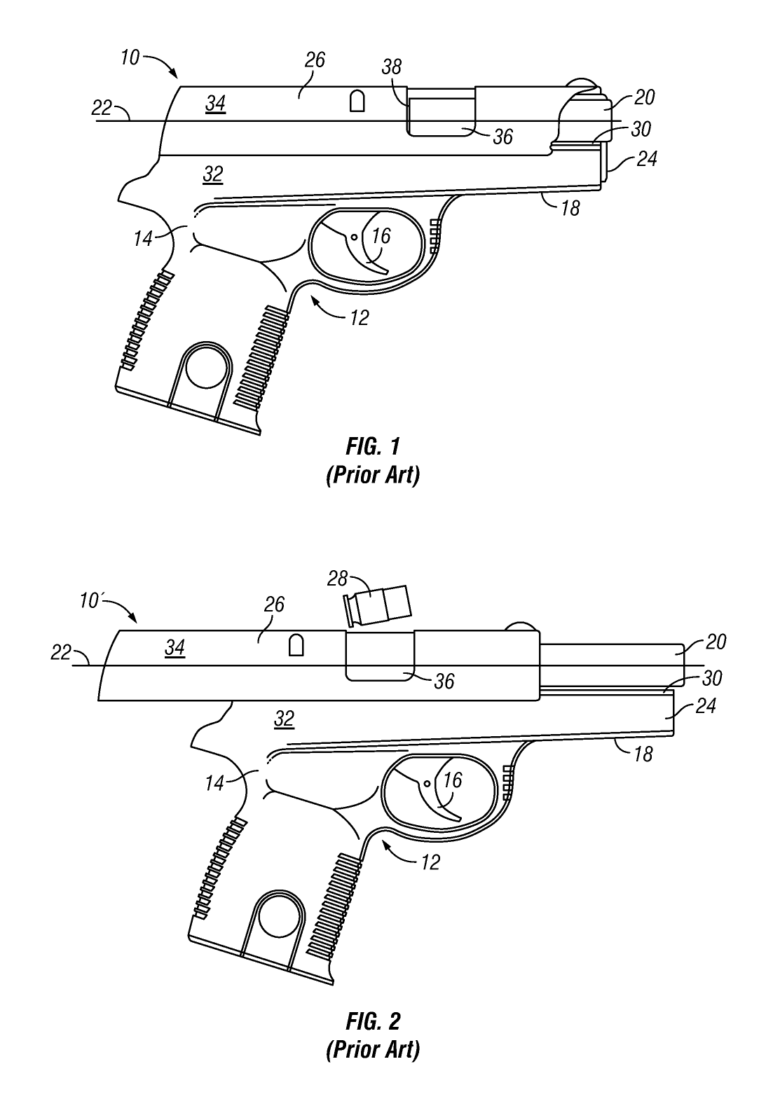

Referring to FIGS. 1 and 2, one example of a firearm, handgun or pistol (hereinafter referred to as “firearm 10”) that is known in the art is shown. The firearm 10 includes a frame 12 having a grip 14 for holding the firearm 10, a trigger 16 for actuating a firing mechanism, a barrel 20 that defines a firing axis 22 of the firearm 10, and a lower muzzle portion 24 that underlies the barrel 20. The trigger 16 is disposed along a bottom surface 18 of the frame 12. A slide 26 is mounted to the frame 12 and houses the barrel 20 at a front end thereof. The barrel 20 is cooperatively linked with the slide 26. A rearward end of the barrel 20 is adapted for receiving an ammunition cartridge 28.

The slide 26 is fitted to ride against oppositely positioned rails 30 on each side 32 of the frame 12 to maintain the reciprocal movement of the slide 26 along the longitudinal firing axis 22. The rails 30 extend along the underside of the slide 26 in the longitudinal direction and are cooperative with the frame 12 to allow the cycling of the slide 26 between forward (battery) and rearward (retired) positions. The slide 26, which is defined by a slide frame 34, further includes a breech face 36 and an extractor port 38. The breech face 36 is engageable with the rearward end of the barrel 20 to form a firing chamber when the slide 26 is disposed forwardly on the frame 12 as shown in FIG. 1. An ejection mechanism provides for the ejection of an ammunition cartridge 26 casing upon firing of the firearm 10 or manually cycling of the slide 26.

The cooperation of the frame 12, the trigger 16, the barrel 20, the slide 26, and the firing mechanism during the loading, firing, and ejecting of an ammunition cartridge 28 or a cartridge casing can be understood by referring to U.S. Pat. No. 5,086,579 entitled “DECOCKING MECHANISM FOR A SEMI-AUTOMATIC FIREARM”; U.S. Pat. No. 5,386,659 entitled “FIRE CONTROL MECHANISM FOR SEMI-AUTOMATIC FIREARMS”; and U.S. Pat. No. 5,406,731 entitled “HANDGUN OF IMPROVED ERGONOMIC CONSTRUCTION,” all of which are owned by the assignee of the present invention and are incorporated by reference herein. U.S. Pat. No. 5,014,456 entitled “CARTRIDGE MAGAZINE FOR SEMI-AUTOMATIC FIREARMS”; U.S. Pat. No. 5,060,555 entitled “SLIDE DECELERATOR FOR A FIREARM”; U.S. Pat. No. 5,492,689 entitled “RECOIL MECHANISM FOR HANDGUNS”; U.S. Pat. No. 5,402,593 entitled “SAFETY TRIGGER FOR A FIREARM”; U.S. Pat. No. 5,437,118 entitled “FRAME PLUG FOR SEMI-AUTOMATIC HANDGUNS”; U.S. Pat. No. 5,438,783 entitled “BUTT PLATE ASSEMBLY FOR HANDGUN MAGAZINES”; U.S. Pat. No. 5,438,784 entitled “MAGAZINE SAFETY”; U.S. Pat. No. 5,566,487 entitled “INTEGRAL BUTT PLATE WITH LATCH AND CATCH MECHANISMS FOR PISTOL MAGAZINE”; U.S. Pat. No. 5,615,505 entitled “MAGAZINE CARTRIDGE GUIDE”; and U.S. Pat. No. 5,717,156 entitled “SEMI-AUTOMATIC PISTOL”, are also owned by the assignee of the present invention and are incorporated by reference herein.

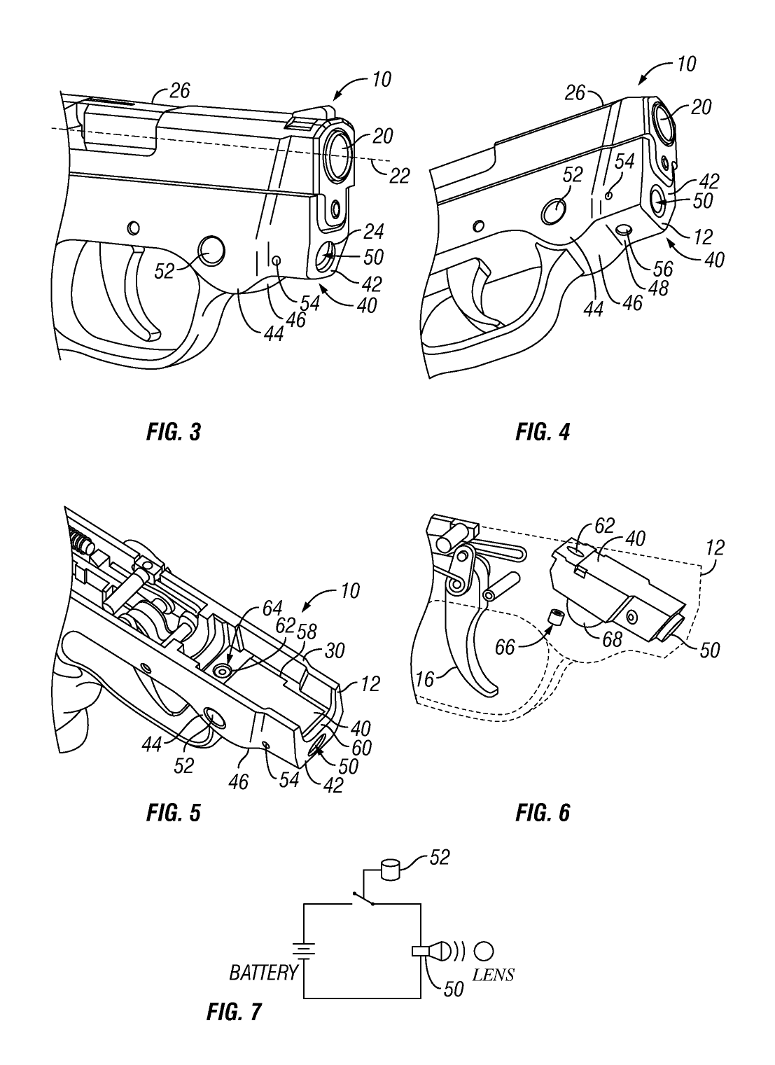

Referring to FIGS. 3 and 4, the front end of the firearm 10 having a light emitting apparatus 40, such as a laser aiming device, installed in the frame 12 is shown. The frame 12 defines a number of pass-thru holes in the lower muzzle portion 24 for providing access points for the light emitting apparatus 40. At the front end of the firearm 10, a first opening 42 is defined in the frame 12 at a central location underlying the barrel 20. A light, such as a laser 50, of the light emitting apparatus 40 is disposed within the first opening 42 and is aligned, generally, with the firing axis 22. Due to the positioning of the first opening 42 relative to the barrel 18, the centerline of the axis of the laser 50 is close in proximity to the centerline of the firing axis 22 to reduce the amount of divergence between the beam of the laser 50 and the firing axis 22 of the barrel 18 and to reduce the need to adjust the orientation of the laser based on the distance to the target.

Along each side 32 of the firearm 10, second openings 44 are defined in the frame 12 at locations substantially adjacent to the trigger 16. For instance, the second openings 44 are located at the juncture of a trigger guard and the frame 12. Activation switches 52 of the light emitting apparatus 40 are disposed within the second openings 44. When one of the activation switches 52 is actuated, the light emitting apparatus 40 is turned from “on” to “off”, and visa versa, which causes the laser 50 to emit or cease emitting.

Since one of the second openings 44 and, correspondingly, one of the activation switches 52 are disposed on each side 32 of the frame 12, the light emitting apparatus 40 can be activated with similar ease whether the firearm 10 is held in the left or right hand of the user.

Along one side 32 of the firearm 10, a third opening 46 is defined in the frame 12. A windage adjustment element 54 of the light emitting apparatus 40 is disposed within the third opening 46. When the windage adjustment element 54 is adjusted, the light emitting apparatus 40 changes the lateral orientation of the laser 50 with respect to the firing axis 22. The windage adjustment element 54 is, for instance, a simple mechanical device, such as a screw as shown in FIG. 6. A thread locking agent can be used to prevent the screw from drifting.

Along the bottom surface of the firearm 10, a fourth opening 48 is defined in the bottom surface 18 of the frame 12. An elevation adjustment element 56 of the light emitting apparatus 40 is disposed within the fourth opening 48. When the elevation adjustment element 56 is adjusted, the light emitting apparatus 40 changes the longitudinal orientation of the laser 50 with respect to the firing axis 22. The elevation adjustment element 56 is, for instance, a simple mechanical device, such as a screw as shown in FIG. 4. A thread locking agent can be used to prevent the screw from drifting.

Referring to FIG. 5, the firearm 10 having the light emitting apparatus 40 installed therein is shown. The lower muzzle portion 24 of the frame 12 further defines an inner recess 58 that is sized and shaped to receive the light emitting apparatus 40. The frontward end of the inner recess 58 defines a retaining lip 60. Toward the rear end of the inner recess 58, a bore 62 is formed in the light emitting apparatus 40 for receiving a hold down screw 64.

Referring to FIG. 6, toward the bottom surface 18, the inner recess 58 includes a threaded insert 66 that receives the hold down screw 64 when the hold down screw 64 is inserted into the bore 62 of the light emitting apparatus 40 and the light emitting apparatus 40 is inserted into the inner recess 58. Further, the light emitting apparatus 40 includes a curved protrusion 68 on a bottom surface thereof that is sized and shaped to be received by the inner recess 58.

For illustrative purposes, the installation of the light emitting apparatus 40 in the firearm 10 is described below. First, to gain access to the inner recess 58 of the frame 12, remove the slide 24 according to the customary manner for the firearm 10. Second, insert the front end of the light emitting apparatus 40, which has the laser 50 formed therein, into the first opening 42 of the frame 12 with the curved protrusion 68 pointing toward the inner recess 58. Third, rotate the light emitting apparatus 40 into engagement with the inner recess 58 with the front end of the light emitting apparatus 40 acting as a pivot point. Fourth, insert the hold down screw 64 into the bore 62 and tighten the hold down screw 64 into engagement with the threaded insert 66. To complete the installation, remount the slide 24 on the frame 12. If this is the first installation of the light emitting apparatus 40 or if service was performed, adjust the windage adjust element 54 and the elevation adjust element 56 as needed to align the centerline of the laser 50 with the centerline of the firing axis 22.

To remove the light emitting apparatus 40, the process is simply reversed. To start, remove the slide 24 followed by the hold down screw 64. Then, pivot the light emitting apparatus 40 away from the inner recess 58 and separate the light emitting apparatus 40 from the frame 12.

When the light emitting apparatus 40 is re-installed in the firearm 10, there should be no need to adjust the windage adjust element 54 or the elevation adjust element 56. This allows removal for battery replacement or service while minimizing the need for laser-sight collimation.

It should be appreciated that the windage adjust element 54 and the elevation adjust element 56 are not impacted by the installation or removal process. Therefore, the laser 50 maintains its orientation and alignment relative to the firing axis 22 unless and until the user makes an adjustment to the windage adjust element 54 and the elevation adjust element 56.

It should be appreciated that the light emitting apparatus 40, which is integrally disposed within the frame 12, is protected from harm and tampering and, therefore, reduces the need for laser-sight collimation.

It should be understood that the foregoing description is only illustrative of the invention. Various alternatives and modifications can be devised by those skilled in the art without departing from the broader aspects of the present invention. For instance, the laser aiming device of the present invention can be mounted on any firearm using any firing mechanism. The exact operation of the firearm, although discussed in brief above, is not intended to limit the laser aiming device of the present invention in any way.

Further, the light emitting apparatus may be or additionally may include any conventional illumination device (LED, light bulb, infrared, etc.). Still further, although the laser aiming device is described as being retained by a screw and threaded insert, another means for fastening may also be used (snap-fit tabs, push-buttons, etc.).

For example, the present invention is particularly suited for use with firearms having non-metallic components, as disclosed in U.S. patent application Ser. No. 12/648,902 entitled “FIREARM HAVING NONMETALLIC COMPONENTS”; U.S. patent application Ser. No. 12/650,038 entitled “AN AUTOMATIC FIRING PIN BLOCK SAFETY FOR A FIREARM”; U.S. patent application Ser. No. 12/650,124 entitled “A MANUAL SLIDE AND HAMMER LOCK SAFETY FOR A FIREARM”; U.S. patent application Ser. No. 12/650,217 entitled “A CONFIGURABLE SIGHT FOR A FIREARM”; U.S. Provisional Patent Application No. 61/169,356 entitled “FIREARM HAVING NONMETALLIC COMPONENTS AND AN AMBIDEXTROUS CYLINDER RELEASE LEVER”; U.S. Provisional Patent Application No. 61/169,359 entitled “FIREARM HAVING NONMETALLIC COMPONENTS AND AN EXTRACTOR YOKE LOCKUP”; and U.S. Provisional Patent Application No. [Applicant's Attorney's Reference Number 5001-0570] entitled “TWO-PIECE TRIGGER AND SPRING RETENTION SYSTEM”, which are owned by the assignee of the present invention and are incorporated by reference herein.

What is claimed is:

1. A firearm for illuminating a target located at a distance from the firearm, the firearm comprising:
a frame having a grip for holding the firearm;
a slide assembly attached along a top of the frame, the slide assembly housing a barrel at a front end thereof, the barrel defining a firing axis of the firearm, the frame having a lower muzzle portion defining a inner recess at a location forward of the grip and below the barrel; and
a light emitting apparatus positioned within in the inner recess at a location below the slide assembly, the light emitting apparatus being retained within the frame upon removal of the slide assembly from the frame by a fastening means.

2. The firearm of claim 1, wherein the light emitting apparatus includes a light source selected from the group consisting of a laser, a LED, a light bulb, and other conventional light source.

3. The firearm of claim 1, wherein the light emitting apparatus is integrally formed with the frame of the firearm.

4. The firearm of claim 1, wherein the light emitting apparatus is substantially surrounded by the frame to provide protection against impact to the light emitting apparatus.

5. The firearm of claim 1, wherein the light emitting apparatus includes an adjustment mechanism for changing a direction of a light emitted from the light emitting apparatus.

6. The firearm of claim 5, wherein the direction of the light emitted from the light emitting apparatus is adjustable with the light emitting apparatus being mounted within the frame.

7. The firearm of claim 5, wherein the light emitting apparatus has a complimentary shape to the recess in the frame such that the direction of the light emitted from the light emitting apparatus is unaffected by removal and installation of the light emitting apparatus from and to the frame.

8. The firearm of claim 1, wherein the adjustment mechanism for changing the direction of a light emitted from the light emitting apparatus is accessed through a bottom hole in the bottom of the frame to adjust the elevation of the light emitted from the light emitting apparatus.

9. The firearm of claim 1, wherein the adjustment mechanism for changing the direction of a light emitted from the light emitting apparatus is accessed through a side hole in the side of the frame to adjust the windage of the light emitted from the light emitting apparatus.

10. The firearm of claim 1, wherein the light emitting apparatus is mounted to the top of the frame when the slide assembly is removed from the frame.

11. The firearm of claim 1, wherein the frame defines at least two activation side holes on each side of the frame, the light emitting apparatus having two activation switches, each of the activation switches dimensioned to be accessible through one of the activation side holes.

12. The firearm of claim 1, wherein the inner recess of the lower muzzle portion is curved and the light emitting apparatus includes a curved protrusion sized and shaped to be complimentary to the curve of the bottom surface of the frame.

13. A method for removing a light emitting apparatus from a firearm, the steps comprising:
providing a firearm having:
a frame having a grip for holding the firearm;
a slide assembly attached along a top of the frame, the slide assembly housing a barrel at a front end thereof, the barrel defining a firing axis of the firearm, the frame having a lower muzzle portion defining a inner recess at a location forward of the grip and below the barrel; and
a light emitting apparatus positioned within in the inner recess at a location below the slide assembly, the light emitting apparatus being retained within the frame upon removal of the slide assembly from the frame;
removing the slide assembly from the frame to access the light emitting apparatus housed within the inner recess of the frame; and
removing the light emitting apparatus.

14. The method of claim 13 further comprising the steps of:
installing a second light emitting apparatus within the inner recess of the frame, and attaching the slide assembly to the frame having the second light emitting apparatus.

15. The method of claim 14 further comprising the step of:
adjusting an adjustment mechanism of the light emitting apparatus through a hole in the frame to change the direction of a light emitted from the light emitting apparatus.

16. A light emitting apparatus for use in a firearm having a slide assembly housing a barrel at a front end thereof, and a frame attached to the bottom of the slide assembly, having a grip and a lower muzzle portion defining a inner recess at a location forward of the grip and below the barrel, the light emitting apparatus comprising:
an outer body having a complementary size and shape to the inner recess of the frame;
a light source;
a light emitting apparatus positioned within in the inner recess at a location below the slide assembly, the light emitting apparatus being retained within the frame upon removal of the slide assembly from the frame.

17. The light emitting apparatus of claim 16, wherein the light source is selected from the group consisting of a laser, a LED, a light bulb, and other conventional light source.

18. The light emitting apparatus of claim 16, wherein the outer body is configured to be substantially surrounded by the frame to provide protection against impact to the light emitting apparatus when the light emitting apparatus is mounted within the frame of the firearm.

19. The light emitting apparatus of claim 18, further comprising an adjustment mechanism for changing a direction of a light emitted from the light emitting apparatus.

20. The firearm of claim 1, wherein the adjustment mechanism for changing the direction of a light emitted from the light emitting apparatus is located to be accessed through a hole in the frame to adjust the direction of the light emitted from the light emitting apparatus, the hole in the frame being located forward of the trigger for access by an index finger of a user.
